(19) United States
(12) Patent Application Publication
(10) Pub. No.: US 2009/0175568 A1
(43) Pub. Date: Jul. 9, 2009

(54) Sensor-Equipped Bearing for Wheel

(75) Inventors: Takayoshi Ozaki, Shizuoka (JP); Tomomi Ishikawa, Shizuoka (JP); Kentarou Nishikawa, Shizuoka (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 12/226,565

(22) PCT Filed: Apr. 11, 2007
(86) PCT No.: PCT/JP2007/000395

§ 371 Date: Oct. 22, 2008

(30) Foreign Application Priority Data
Apr. 24, 2006 (JP) 2006-119092

(51) Int. Cl. F16C 41/00

(52) U.S. Cl. 384/448

(57) ABSTRACT

To provide a sensor equipped wheel support bearing assembly, in which a load sensor can be snugly and neatly installed in automotive vehicle and which detects the load or the like acting on a vehicle wheel and requires an inexpensive cost in mass production. A sensor unit is fitted to an outer member as a stationary member of the bearing assembly. The sensor unit includes a sensor mounting member having bolt insertion holes alignable with vehicle body fitting holes of the outer member, and a strain sensor fitted to the sensor mounting member. This sensor unit is sandwiched between the outer member and a knuckle and is fitted by means of bolts inserted through the vehicle body fitting holes and the bolt insertion holes. The sensor unit has a portion that is greater in a radial direction than a flange of the outer member.

### BACKGROUND OF THE INVENTION

1. Field of the Invention

The present invention relates to a sensor equipped wheel support bearing assembly having a load sensor built therein for detecting a load imposed on a bearing unit for a vehicle wheel.

2. Description of the Prior Art

For safety travel of an automotive vehicle, the wheel support bearing assembly has hitherto been well known in the art, which is equipped with a sensor for detecting the rotational speed of each of automotive wheels. While the automobile traveling safety precaution is generally taken by detecting the rotational speed of a vehicle wheel of various parts, it is not sufficient with only the rotational speed of the wheel and, therefore, it is desired to achieve a control for safety purpose with the use of other kinds of sensor signals.

In view of the above, it may be contemplated to achieve the vehicle attitude control based on a load acting on each of the wheels during travel of an automotive vehicle. By way of example, a large load acts on the outside wheels during the cornering, on the wheels on one side during the run along left and right inclined road surfaces or on the front wheels during the braking, and, thus, a varying load acts on the vehicle wheels. Also, even in the case of the uneven live load, the loads acting on those wheels tend to become uneven. For this reason, if the loads acting on the wheels can be detected as needed, suspension systems for the vehicle wheels can be controlled beforehand based on results of detection of the loads so that the attitude of the automotive vehicle during the traveling thereof (for example, prevention of a rolling motion during the cornering, prevention of diving of the front wheels during the braking, and prevention of diving of the vehicle wheels brought about by an uneven distribution of live loads) can be accomplished. However, no suitable space for installation of the load sensor for detecting the load acting on the respective vehicle wheel is available and, therefore, the attitude control through the detection of the load is hardly realized.

Also, in the event in the near future the steer-by-wire is introduced and the system, in which the wheel axle and the steering come not to be coupled mechanically with each other, is increasingly used, information on the road surface comes to be required to transmit to the steering wheel hold by a driver by detecting a wheel axis direction load.

In order to meet those needs hitherto recognized, the wheel support bearing assembly has been suggested in which a strain sensor is affixed to an outer ring of the wheel support bearing assembly so that the strain can be detected. (See, for example, the Japanese Laid-open Patent Publication No. 2003-530565, published Oct. 14, 2003.)

The outer ring of the wheel support bearing assembly is a bearing component part which has a raceway defined therein, requires a strength and is made by means of complicated manufacturing steps including, for example, turning, heat treatment, grinding and others. Accordingly, where the strain gauge is affixed to the outer ring such as disclosed in the patent document referred to above, problems arise that the productivity is low and the manufacturing cost thereof at high volume is increased.

### SUMMARY OF THE INVENTION

In order to accomplish the foregoing object, the present invention is intended to provide a sensor equipped wheel support bearing assembly, in which a sensor for detecting a load can be snugly and neatly installed in an automotive vehicle and which is capable of detecting the load or the like acting on a vehicle wheel and require an inexpensive cost in mass production.

The sensor equipped wheel support bearing assembly of the present invention is a wheel support bearing for rotatably supporting the vehicle wheel relative to a vehicle body structure, which includes an outer member having an inner periphery thereof formed with a plurality of rows of raceways, an inner member formed with raceways in face-to-face relation with the respective raceways in the outer member, and a plurality of rows of rolling elements interposed between the respective raceways in the outer and inner members. This wheel support bearing also includes a sensor unit made up of a sensor mounting member having bolt insertion holes defined therein in a relation alignable with respective vehicle body fitting holes defined in one of the outer member and the inner member that serves as a stationary member; and at least one strain sensor mounted on the sensor mounting member, and fixedly sandwiched between the stationary member and a knuckle by means of bolts inserted through the vehicle body fitting holes and the bolt insertion holes, in which the sensor unit has a portion that has a radial dimension greater than that of a flange provided in the stationary member in contact with the knuckle.

In the event that a load acts on a rotating member as the automotive vehicle starts traveling, the stationary member undergoes deformation through the rolling elements and such deformation brings about a strain in the sensor unit. The strain sensor provided in the sensor unit detects the strain occurring in the sensor unit. By determining beforehand the relation between the strain and the load by means of a series of experiments and/or simulations, the load imposed on the vehicle wheel and a steering moment of the automotive vehicle can be detected from an output of the strain sensor. Also, the load and the steering moment so detected can be utilized in the vehicle control of an automotive vehicle. The steering moment referred to above is the moment acting on the vehicle bearing at the time the automotive vehicle travels along a curved road.

This wheel support bearing assembly is of a design, in which the sensor unit including the sensor mounting member and the strain sensor mounted on the sensor mounting member is fitted, having been sandwiched between the stationary member and the knuckle by the bolts for connecting the stationary member and the knuckle together, which bolts are passed through the vehicle body fitting holes and the bolt insertion holes. Accordingly, the sensor for the detection of the load can be compactly and easily installed in the automotive vehicle without any extra mounting members being employed. Since the sensor unit has that portion that is greater in the radial direction than the flange in the stationary member, positioning of the strain sensor at that portion makes it possible for the strain sensor to be provided without interfering with the stationary member and the knuckle. Since the sensor mounting member is a simple component part that is fitted, having been sandwiched between the stationary member and the knuckle, fitting of the strain sensor thereto is effective to provide an excellent mass productivity and to reduce the cost.

In the present invention, the strain sensor may be arranged on an upper or lower portion of the sensor mounting member or both of the upper and lower portions of the sensor mounting member. In such case, the load acting on the automotive vehicle can be calculated from an output of the strain sensor.

Also, in the present invention, the strain sensor may be arranged at a location of the sensor mounting member forwardly or rearwardly, or at both of those locations thereof, with respect to the direction of travel of the automotive vehicle. In such case, the steering moment of the automotive vehicle can be calculated from the output of the strain sensor.

The sensor unit referred to above may be of a type capable of detecting a force generated between the flange in the stationary member and the knuckle as a strain. Since the sensor unit is of a type that is fitted sandwiched between the flange in the stationary member and the knuckle, the force generated therebetween can be accurately and easily detected by the sensor unit.

When the force generated between the flange in the stationary member and the knuckle is detected, a condition of connection between the stationary member and the knuckle can be grasped.

The stationary member referred to above may be the outer member. In such case, the sensor unit is fitted sandwiched between the outer member and the knuckle.

It is preferred to use an acting force estimation section for estimating an external force acting on the wheel support bearing assembly or an acting force acting between a wheel tire and the road surface based on the output of the strain sensor.

When the external force acting on the wheel support bearing assembly or the acting force acting between a wheel tire and the road surface, which can be obtained from the acting force estimation section, is used in a vehicle control of the automotive vehicle, a meticulous vehicle control can be accomplished.

A temperature sensor may be provided in the sensor mounting member.

Since the temperature of the wheel support bearing assembly undergoes a change during the use, such change in temperature affects the strain occurring in the sensor mounting member or the operation of the strain sensor. Also, change in ambient temperature in the environment brings about similar influences. The load detection with a high precision can be accomplished by correcting a temperature dependent characteristic of the strain sensor using an output of the temperature sensor.

At least one of an acceleration sensor and a vibration sensor may be provided in the sensor mounting member.

When additional sensors including, for example, the acceleration sensor and the vibration sensor is mounted on the sensor mounting member together with the strain sensor, the load and the state of the wheel support bearing assembly can be measured all at one location and, therefore, wirings, for example, can be simplified.

The strain sensor referred to above may include an insulating layer formed on a surface of the sensor mounting member by means of printing and baking and electrodes and a strain measuring resistance element both formed on the insulating layer by means of printing and baking.

Where the strain sensor is so formed as described above, no reduction in bonding strength with aging such as observable when the strain sensor is bonded to the sensor mounting member with a bonding agent take place and, therefore, the reliability of the sensor unit can be increased. Also, since the processing is easy, the cost can be reduced.

A sensor signal processing circuit unit including a sensor signal processing circuit for processing an output signal of the strain sensor may be provided in proximity to the sensor unit.

The provision of the sensor signal processing circuit unit in proximity of the sensor unit is effective to simplify the wiring and labor required to connect the sensor unit with the sensor signal processing circuit unit. Also, as compared with the case in which the sensor signal processing circuit unit is provided at a location other than the wheel support bearing assembly, the sensor signal processing circuit unit can be installed compactly.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a diagram showing a cross-sectional view of a sensor equipped wheel support bearing assembly according to a first preferred embodiment of the present invention taken along the line I-I in FIG. 2, together with a block diagram of a conceptual construction of a detecting system therefor;

FIG. 2 is a front elevational view showing an outer member of the sensor equipped wheel support bearing assembly according to the first preferred embodiment and a sensor unit employed therein;

FIG. 3 is a front elevational view of the sensor unit;

FIG. 4 is a front elevational view showing the outer member of the different sensor equipped wheel support bearing assembly and the sensor unit employed therein;

FIG. 5 is a front elevational view showing the outer member of the sensor equipped wheel support bearing assembly according to a second preferred embodiment of the present invention and the sensor unit employed therein;

FIG. 6 is a front elevational view showing the outer member of the sensor equipped wheel support bearing assembly according to a third preferred embodiment of the present invention and the sensor unit employed therein;

FIG. 7 is a diagram showing a sectional structure of a modified form of the sensor unit;

FIG. 8 is a cross-sectional view showing the sensor equipped wheel support bearing assembly according to a fourth preferred embodiment of the present invention taken along the line VIII-VIII in FIG. 9;

FIG. 9 is a front elevational view showing the outer member of the sensor equipped wheel support bearing assembly according to the fourth preferred embodiment and the sensor unit employed therein;

FIG. 10 is a top plan view showing a sensor signal processing circuit unit shown in FIG. 9;

FIG. 11 is a diagram showing a cross-sectional view of the sensor equipped wheel support bearing assembly according to a fifth preferred embodiment of the present invention taken along the line XI-XI in FIG. 12, together with a block diagram of a conceptual construction of the detecting system therefor;

FIG. 12 is a front elevational view showing the outer member of the sensor equipped wheel support bearing assembly according to the fifth preferred embodiment and the sensor unit employed therein;

FIG. 13 is a front elevational view showing the sensor unit;

FIG. 14 is a front elevational view showing the outer member of the sensor equipped wheel support bearing assembly according to a sixth preferred embodiment of the present invention and the sensor unit employed therein;

FIG. 15 is a front elevational view showing the outer member of the sensor equipped wheel support bearing assembly according to a seventh preferred embodiment of the present invention and the sensor unit employed therein;

FIG. 16 is a front elevational view showing the outer member of the sensor equipped wheel support bearing assembly according to an eighth preferred embodiment of the present invention and the sensor unit employed therein; and

FIG. 17 is a front elevational view showing the outer member of the sensor equipped wheel support bearing assembly according to a ninth preferred embodiment of the present invention and the sensor unit employed therein.

### DETAILED DESCRIPTION OF THE EMBODIMENTS

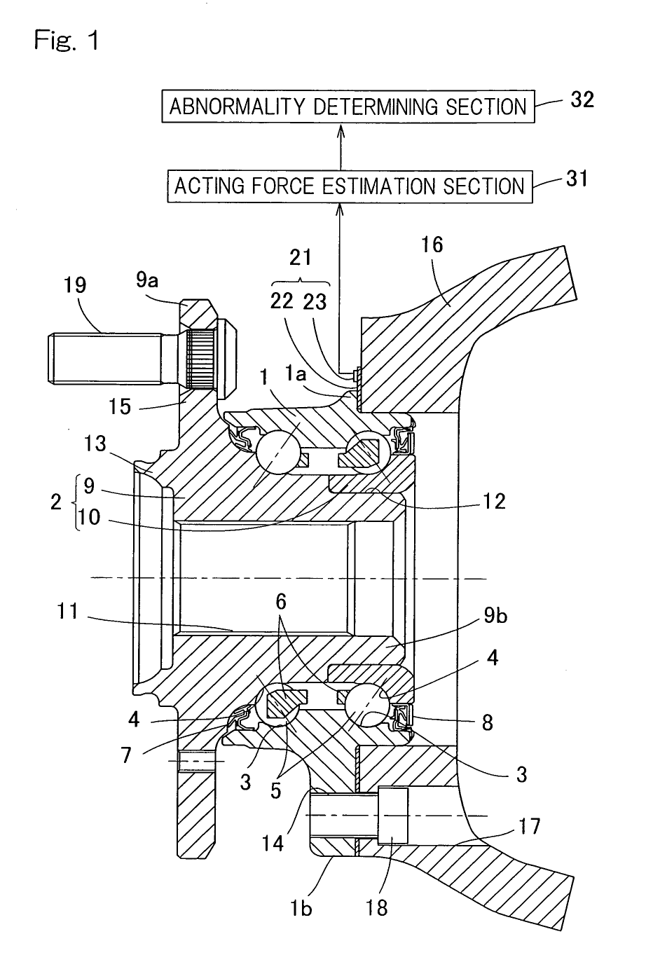

A first preferred embodiment of the present invention will be described in detail with particular reference to FIGS. 1 to 3. This embodiment is directed to an inner race rotating model of a third generation type, which is applied to a wheel support bearing assembly for the support of a vehicle drive wheel. It is to be noted that hereinafter in this specification, terms “outboard” and “inboard” represent one side of a vehicle body away from the longitudinal center of the vehicle body and the other side of the vehicle body close to the longitudinal center of the vehicle body, respectively.

The sensor equipped wheel support bearing assembly according to this embodiment includes an outer member 1 having its inner periphery formed with a plurality of raceways 3, an inner member 2 formed with raceways 4 opposed to the respective raceways 3, and a plurality of rows of rolling elements interposed between the raceways 3 of the outer member 1 and the raceways 4 of the inner member 2. This wheel support bearing assembly is in the form of a double row angular contact ball bearing type, in which the rolling elements 5 are employed in the form of balls that are rollingly retained by a retainer 6 employed for each row. The raceways 3 and 4 have an arcuately sectioned shape and the raceways 3 and 4 are so formed as to have a contact angle oriented outwardly. Opposite annular open ends of a bearing space delimited between the outer member 1 and the inner member 2 are sealed by respective sealing devices 7 and 8.

The outer member 1 serves as a stationary member and is of one-piece construction in its entirety. The outer member 1 includes a flange 1a formed in an outer periphery thereof for connection with a knuckle 16 extending from a suspension system (not shown) of an automotive vehicle. The flange 1a has a plurality of (for example, four, in the illustrated embodiment) knuckle fitting lugs 1b defined at respective circumferential locations of the flange 1a so as to extend radially outwardly a distance greater than that of any other portion thereof, and each of those knuckle fitting lugs 1b has an internally threaded vehicle body fitting hole 14 defined therein. An inboard surface of the flange 1a is formed flat.

On the other hand, the knuckle 16 has a stepped knuckle bolt hole 17 provided therein at a location corresponding to each of the vehicle body fitting holes 14. When while the inboard surface of the flange 1a and an outboard end face of the knuckle 16 are held in abutment with each other through a sensor unit 21 as will be described later, the knuckle bolts 18 inserted from the side of the respective knuckle bolt holes 17 are threaded into the associated vehicle body fitting holes 14, the outer member 1 and the knuckle 16 are integrally fixed together.

The inner member 2 is the one that serves as a rotating member and is made up of a hub axle 9 having a hub flange 9a for the support of a vehicle wheel, and an inner ring 10 mounted on an inboard end of a hub axle 9b of the hub axle 9. The hub axle 9 and the inner ring 10 are respectively formed with the raceways 4 referred to previously. The inboard end of the hub axle 9 has its outer periphery radially inwardly stepped to define an inner ring mounting area 12 of a reduced diameter, with the inner ring 10 fixedly mounted thereon. The hub axle 9 has a center bore 11 defined therein so as to extend completely through the length of the hub axle 9. The hub flange 9a has a plurality of press-fitting holes 15 defined in respective circumferential locations thereof for receiving the corresponding hub bolts 19 that are press-fitted therein. The hub flange 9a of the hub axle 9 has a root portion thereof formed with a cylindrical pilot portion 13 so as to protrude in an outboard direction, which pilot portion 13 serves to guide the vehicle wheel and brake components (not shown).

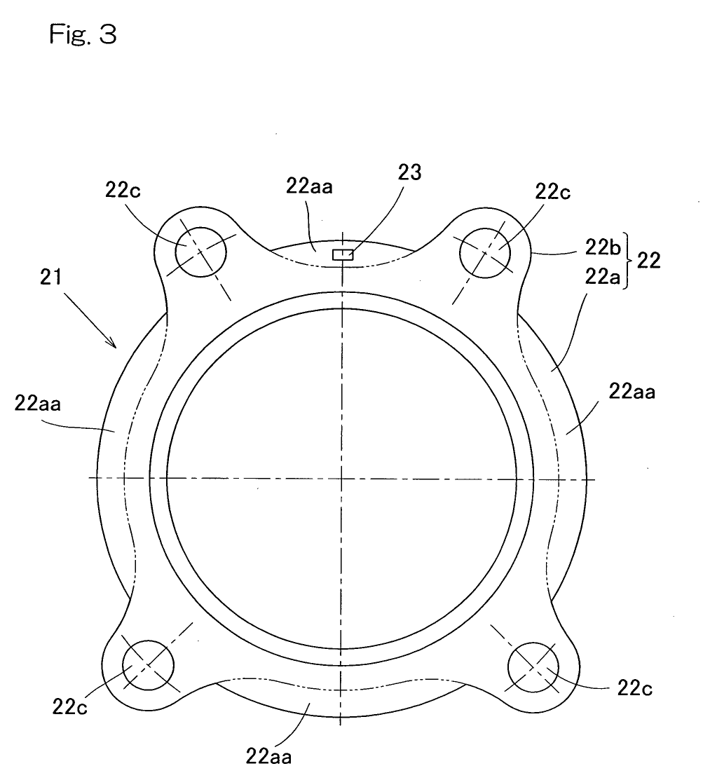

The sensor unit 21 is best shown in FIG. 3. This sensor unit 21 is made up of a sensor mounting member 22 and a strain sensor 23 for measuring the strain mounted on the sensor mounting member 22. The sensor mounting member 22 is in the form of a thin walled plate member including an annular portion 22a of a diameter greater than the outer diameter of the flange 1a (the site other than the knuckle fitting lugs 1b) in the outer member 1 and protruding lobes 22b corresponding to the knuckle fitting lugs 1b. Each of those protruding lobes 22b is provided with a knuckle bolt insertion hole 22c defined therein in a relation alignable with the corresponding vehicle body fitting hole 14 and the corresponding knuckle bolt hole 17. The strain sensor 23 is fitted to a sensor mounting area 22aa of the annular portion 22a, which area 22aa has a radial dimension greater than that of the flange 1a. In the case of the illustrated embodiment, the strain sensor 13 is arranged in one of the four sensor mounting areas 22aa, which is located in an upper portion.

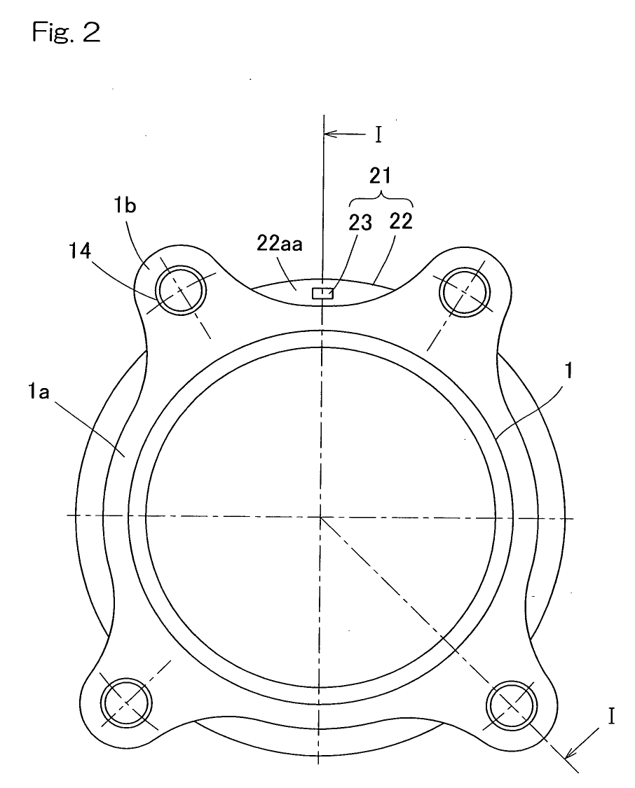

The sensor unit 21 referred to above is, as shown in FIGS. 1 and 2, fixedly sandwiched between the flange 1a in the outer member 1 and the knuckle 16, having been fastened therebetween by means of the knuckle bolts 18. In this mounted condition, the strain sensor 23 is positioned upwardly beyond the flange 1a. The sensor mounting member 22 has such a shape, and is made of such a material, that no plastic deformation occurs in the sensor mounting member 22 when the sensor unit 21 is fixed in the manner described above.

Also, the sensor mounting member 22 is required to have such a shape that no plastically deformation occurs in the sensor mounting member 22 even when a maximum expected load is applied to the wheel support bearing assembly. The maximum expected force referred to above is a maximum force that can be assumed during the travel of the automotive vehicle that does not lead to a trouble in such automotive vehicle. Once the sensor mounting member 22 is plastically deformed, deformation occurring in the outer member 1 will not be transmitted to the sensor mounting member 22 accurately, thus adversely affecting the measurement of the strain.

The sensor mounting member 22 of this sensor unit 21 may be manufactured by means of, for example, a press work. If the sensor mounting member 22 is a product prepared by the use of a press work, the cost can be reduced.

Also, the sensor mounting member 22 may be a product of a sintered metal that is formed by means of a powdery metal injection molding technique. The injection molding of a powdery metal is one of molding techniques used in molding a metal or an intermetallic compound and includes a step of kneading the powdery metal with a binder, a step of molding the kneaded mixture by means of an injection molding, a step of degreasing the resultant molded article and a step of sintering the molded article. With this injection molding of the powdery metal, some advantages can be appreciated where a sintered body of a high sintered density can be obtained as compared with the standard powdery metallurgy and a sintered metal product can also be prepared with a high dimensional accuracy and can have a high mechanical strength.

For the strain sensor 23, any of various sensors may be employed. For example, where the strain sensor 23 is in the form of a metallic foil strain gauge, in consideration of the durability of the metal foil strain gauge, the amount of strain occurring at a portion of the sensor mounting member 22 on which the strain sensor 23 is mounted is preferred to be smaller than 1500 microstrain even when the maximum expected load is applied on the wheel support bearing assembly. By a reason similar to that described above, where the strain sensor 23 is in the form of a semiconductor strain gauge, the amount of the strain is preferred to be smaller than 1000 microstrain. On the other hand, where the strain sensor 23 is in the form of a thick film type sensor, the amount of the strain is preferred to be smaller than 1500 microstrain.

As shown in FIG. 1, for processing an output of the strain sensor 23, an acting force estimation section 31 and an abnormality determining section 32 are employed. Those sections 31 and 32 may be those provided in an electronic circuit device (not shown) such as, for example, a circuit substrate fitted to the outer member 1 or the like of the wheel support bearing assembly or those provided in an electronic control unit (ECU) of an automotive vehicle.

The operation of the sensor equipped wheel support bearing assembly of the construction described hereinabove will now be described. When the load is applied to the hub axle 9, the outer member 1 is deformed through the rolling elements 5 and such deformation is transmitted to the sensor mounting member 22 that is fitted between the outer member 1 and the knuckle 16, resulting in a corresponding deformation of the sensor mounting member 22. The strain then occurring in the sensor mounting member 22 is measured by the strain sensor 23. In other words, the strain sensor 23 detects a force, developed between the flange 1a in the outer member 1 and the knuckle 16, as a strain.

Considering that variation of the strain differs depending on the direction and/or the magnitude of the load, by determining beforehand the relation between the strain and the load by means of a series of experiment and/or simulations, an external force acting on the wheel support bearing assembly or an acting force between a vehicle tire and the road surface can be calculated. The acting force estimation section 31 referred to previously is operable to calculate the external force acting on the wheel support bearing assembly or the acting force between the vehicle tire and the road surface in reference to an output from the strain sensor 23, using the relation between the strain and the load that has been determined by means of the experiments and/or simulations. On the other hand, the abnormality determining section 32 also referred to previously is operable to output an abnormality signal to the outside in the event that the external force acting on the wheel support bearing assembly and calculated by the acting force estimation section 31 and/or the acting force between the vehicle tire and the road surface having been calculated by the acting force estimation section 31 is determined exceeding a predetermined tolerance. This abnormality signal can be used in vehicle control of the automotive vehicle. Also, by outputting in real time the external force acting on the wheel support bearing assembly and/or the acting force between the vehicle tire and the road surface, a meticulous vehicle control can be achieved.

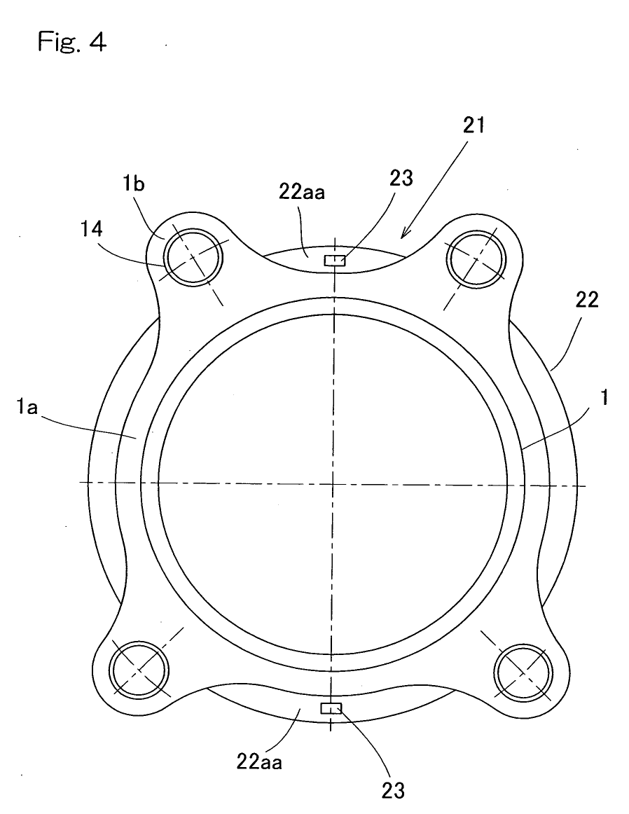

Although the sensor unit 21 according to this embodiment has been shown and described as including only one strain sensor 23 fitted to the uppermost sensor mounting area 22aa of the sensor mounting member 22, a plurality of strain sensors 23 may be fitted to uppermost and lowermost sensor mounting areas 22aa as shown in FIG. 4. Where the plural strain sensors 23 are fitted to the sensor mounting member 22, a further highly accurate load detection can be accomplished. A construction may be possible, in which the only strain sensor 23 is fitted to the lowermost sensor mounting area 22aa.

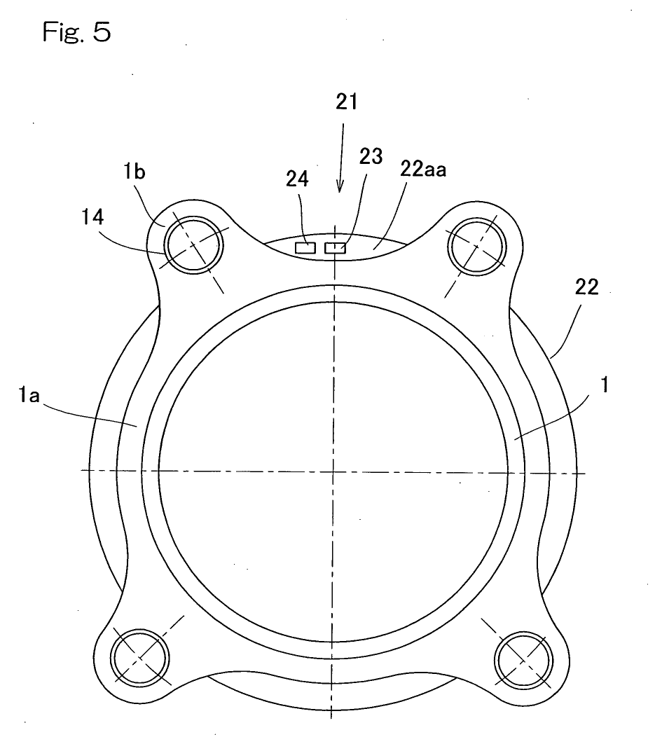

FIG. 5 illustrates a second preferred embodiment of the sensor unit. This sensor unit 21 is provided with a temperature sensor 24 in addition to the strain sensor 23. It is to be noted that the sensor mounting member 22 is of the same shape as that shown in FIG. 3 and both of the strain sensor 23 and the temperature 24 are arranged in the uppermost sensor mounting area 22aa of the sensor mounting member 22. For the temperature sensor 24, a platinum temperature measuring resistance, a thermocouple or a thermister may be employed. Also, other than those, any sensor capable of detecting a temperature may be employed.

Even in this wheel support bearing assembly provided with the sensor unit 21, the strain sensor 23 detects a strain occurring in the sensor mounting member 22 so that the load acting on the vehicle wheel can be measured in terms of such strain. In the meantime, the temperature of the wheel support bearing assembly undergoes a change during the use and such change in temperature affects the strain occurring in the sensor mounting member 22 or the operation of the strain sensor 23. In view of this, the temperature of the sensor mounting member 22 is detected by the temperature sensor 24 arranged on the sensor mounting member 22 and the temperature so detected is utilized to correct an output of the strain sensor 23 so that the influence brought about by the temperature change on the strain sensor 23 can be eliminated. In this way, the highly accurate load detection can be accomplished.

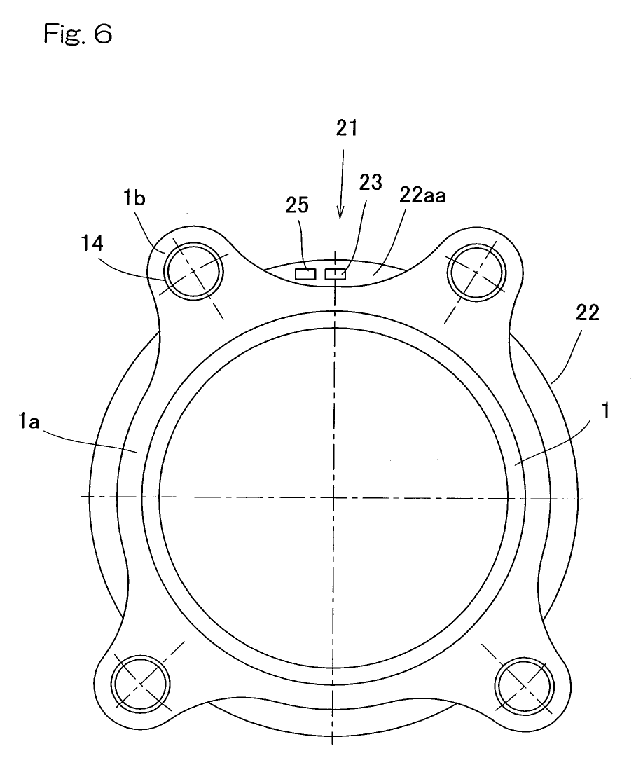

FIG. 6 illustrates a third preferred embodiment of the sensor unit. This sensor unit 21 is provided with an additional sensor 25 in addition to the strain sensor 23. The additional sensors 25 referred to above is at least one of an acceleration sensor and a vibration sensor. It is to be noted that the sensor mounting member 22 has the same shape as that shown in FIG. 3 and any of the strain sensor 23 and the additional sensors 25 are arranged on the uppermost sensor mounting area 22aa of the sensor mounting member 22.

By fitting the strain sensor 23 and the additional sensors 25 to the sensor mounting member 22 in the manner described above, the load and the status of the wheel support bearing assembly can be measured at one location and the wirings can be simplified.

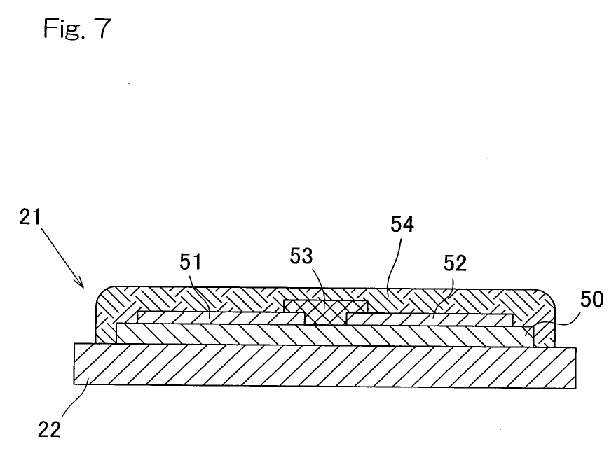

FIG. 7 illustrates the structure of the sensor unit in which the strain sensor is formed by a method different from that according to any one of the foregoing embodiments. The sensor unit 21 shown therein is of a structure including an insulating layer 50 formed on the sensor mounting member 22, a pair of electrodes 51 and 52 formed on a surface of the insulating layer 50, a strain measuring resistance element 53, which eventually forms the strain sensor, formed over the insulating layer 50 and between the pair of the electrodes 51 and 52, and a protective film 54 formed over the electrodes 51 and 52 and the strain measuring resistance element 52.

A method of making such sensor unit 21 will be described hereinafter. At the outset, on a surface of the sensor mounting member 22 made of a metallic material such as a stainless steel or the like, an insulating material such as glass is printed and then baked to form the insulating layer 50. Subsequently, on a surface of the insulating layer 50 so formed, an electroconductive material is printed and then based to form the electrodes 51 and 52. Thereafter, between the electrodes 51 and 52 so formed, a material, which eventually form a resistance element, is printed and then baked to form the strain measuring resistance element 53. Finally, for protecting the electrodes 51 and 52 and the strain measuring resistance element 53, the protective film 54 is formed.

The strain sensor is generally fixed to the sensor mounting member 22 by means of bonding, but such a fixture may adversely affect the detection performed by the strain sensor when the bonding strength is lowered as a result of aging, and constitutes an increase of the cost. In contrast thereto, where the sensor unit 21 is of a structure in which the insulating layer 50 is formed by printing and baking on the surface of the sensor mounting member 22 and the electrodes 51 and 52 and the strain measuring resistance element 53, which forms the strain sensor, are formed by printing and baking, the reliability can be increased and the cost can be reduced.

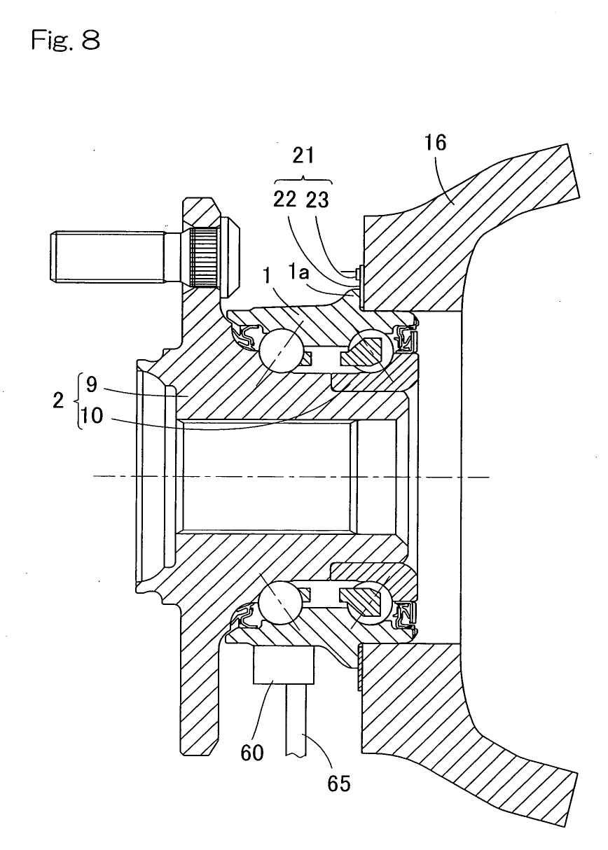

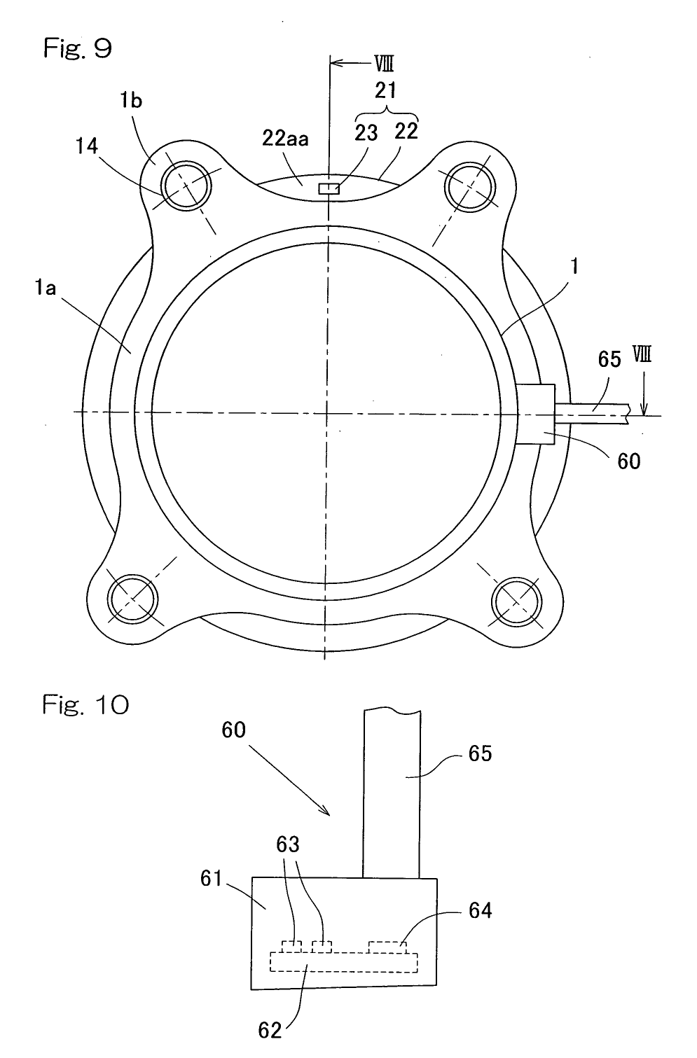

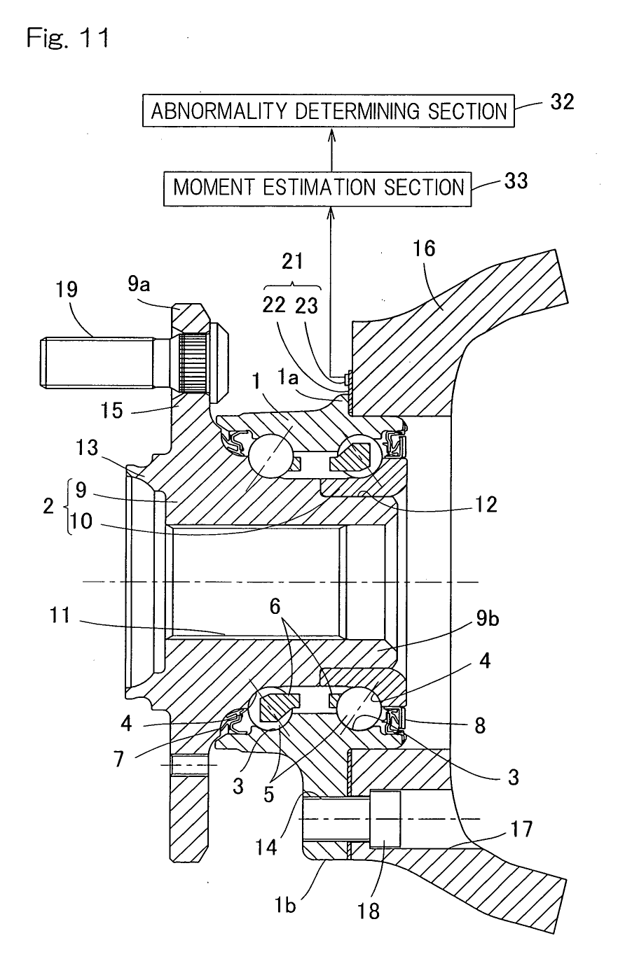

FIGS. 8 to 10 illustrate a fourth preferred embodiment of the present invention. The wheel support bearing assembly shown therein has a sensor signal processing circuit unit 60 incorporated therein for processing respective outputs of the strain sensor and the various types of sensors (temperature sensor, acceleration sensor and vibration sensor), all provided in the sensor unit 21. This sensor signal processing circuit unit 60 is mounted on the outer peripheral surface of the outer member 1.

The sensor signal processing circuit unit 60 includes a circuit substrate 62 made of, for example, a glass epoxy or the like and accommodated within a housing 61 made of a resinous material or the like, and electric and electronic component parts 63 in the form of an operational amplifier, a resistor, and a microcomputer or the like for processing an output signal of the strain sensor 23, and a power supply for driving the strain sensor 23, are arranged on the circuit substrate 62. Also, the sensor signal processing circuit unit 60 has a connector 64 for connecting a wiring of the strain sensor 23 with the circuit substrate 62. In addition, it includes a cable 65 for the electric power supply from the outside and outputting therethrough to the outside output signals processed by the sensor signal processing circuit. Where the sensor unit 21 is provided with the previously described various sensors (temperature sensor, acceleration sensor and vibration sensor) such as in this embodiment, the sensor signal processing circuit unit 60 is provided with the circuit substrates 62, the electric and electronic component parts 63, the connectors 64, the cables 65 and so on (not shown), which are respectively associated with those sensors.

In general, the sensor signal processing circuit unit for processing the respective outputs of the sensors provided in the wheel support bearing assembly is provided in an electric control unit (ECU) of the automotive vehicle, but the provision of the sensor signal processing circuit unit 60 in the vicinity of the sensor unit 21 in the wheel support bearing assembly such as in this embodiment is effective to simplify the labor incurred in connecting the sensor unit 21 with the sensor signal processing circuit unit 60 by means of wiring, and the sensor signal processing circuit unit 60 can be more compactly installed than to provide the sensor signal processing circuit unit 60 at a location other than the wheel support bearing assembly.

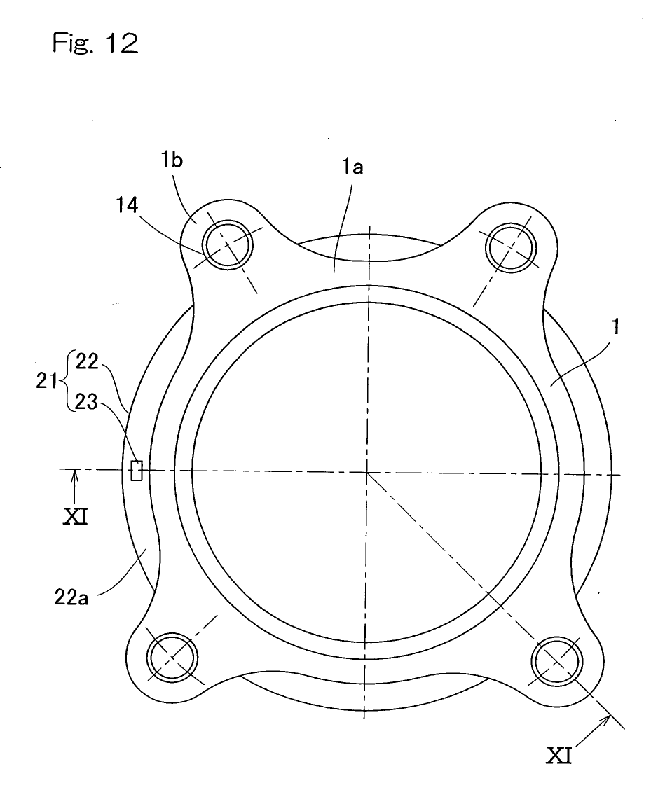

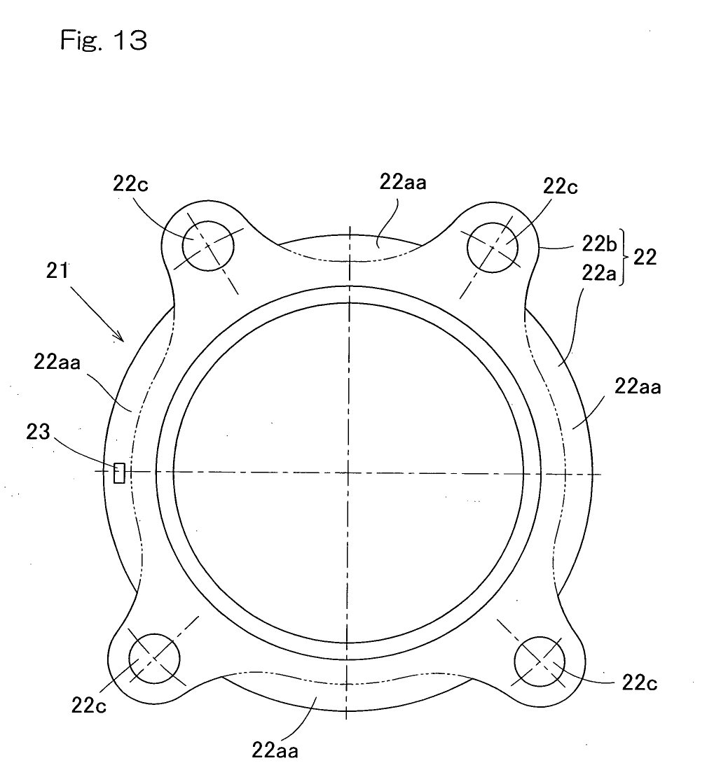

FIGS. 11 to 13 illustrate a fifth preferred embodiment, which is similar to any one of the previously described embodiments, but differs therefrom in respect of the position at which the strain sensor 23 of the sensor unit 21 is arranged. While in any one of the previously described embodiments the strain sensor 23 is arranged in the uppermost or lowermost sensor mounting area 22aa of the sensor mounting member 22 or both of those uppermost and lowermost sensor mounting areas 22aa of the sensor mounting member 22, this embodiment is such that the strain sensor 23 is arranged in one of the sensor mounting areas 22aa of the sensor mounting member 22, which is located forwardly with respect to the direction of travel of the automotive vehicle. Also, as best shown in FIG. 11, as a means for processing the output of the strain sensor 23, a moment estimation section 33 is provided in place of the acting force estimation section 31 employed in any of the foregoing embodiments. Other than those structural features, this embodiment is substantially identical in construction with the embodiment shown in and described with particular reference to FIG. 3 and, therefore, like parts are designated by like reference numeral and the details are not reiterated for the sake of brevity.

Even in this embodiment, when the load is applied to the hub axle 9, the outer member 1 is deformed through the rolling elements 5 and such deformation is transmitted to the sensor mounting member 22 that fitted between the outer member 1 and the knuckle 16, resulting in a corresponding deformation of the sensor mounting member 22. The strain then occurring in the sensor mounting member 22 is measured by the strain sensor 23 fitted to a portion of the sensor mounting member 22 that lies forwardly with respect to the direction of travel of the automotive vehicle.

Considering that variation of the strain differs depending on the direction and/or the magnitude of the load, by determining beforehand the relation between the strain and the load by means of a series of experiment and/or simulations, a steering moment acting on the wheel support bearing assembly can be calculated. The steering moment is a moment acting on the wheel support bearing assembly when the automotive vehicle travels along a curved road. The steering moment estimation section 33 referred to previously is operable to calculate the steering moment acting on the wheel support bearing assembly in reference to an output from the strain sensor 23, using the relation between the strain and the load that has been determined by means of the experiments and/or simulations. On the other hand, the abnormality determining section 32 also referred to previously is operable based on this to output an abnormality signal to the outside in the event that the steering moment acting on the wheel support bearing assembly is determined exceeding a predetermined tolerance. This abnormality signal can be used in vehicle control of the automotive vehicle. Also, by outputting the steering moment acting on the wheel support bearing assembly in real time, a meticulous vehicle control can be achieved.

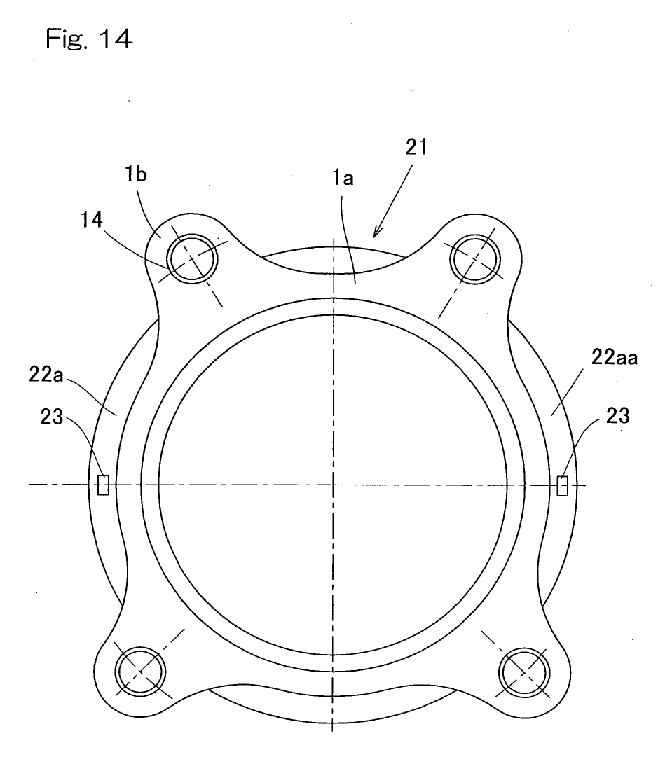

Although the sensor unit 21 according to this embodiment has been shown and described as including only one strain sensor 23 fitted to the forward sensor mounting area 22aa of the sensor mounting member 22 with respect to the direction of travel of the automotive vehicle, a plurality of strain sensors 23 may be fitted to forward and rearward sensor mounting areas 22aa respectively as shown in FIG. 14 in connection with a sixth preferred embodiment of the present invention. Where the plural strain sensors 23 are fitted to the sensor mounting member 22, a further highly accurate detection of the steering moment can be accomplished. A construction may be possible, in which the only strain sensor 23 is fitted to the rearward sensor mounting area 22aa.

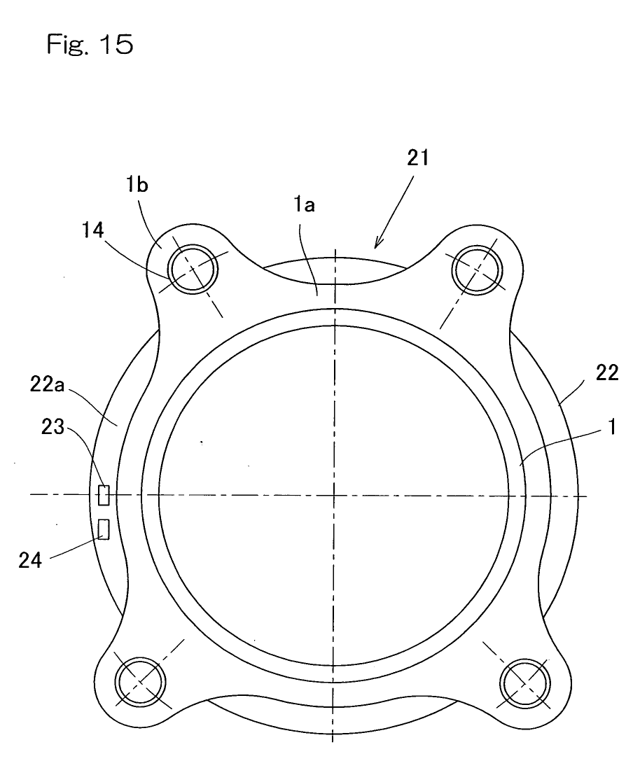

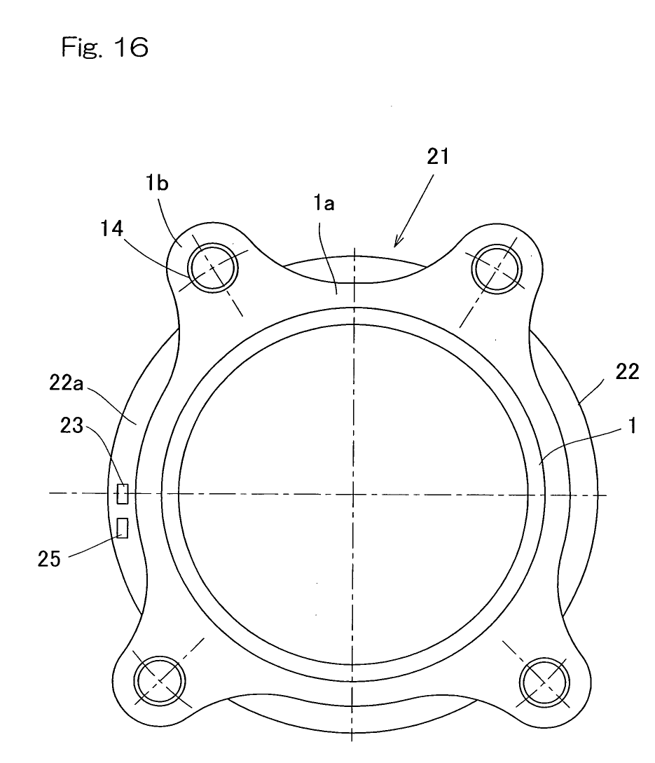

Even in the bearing assembly for the automotive vehicle, in which the strain sensor 23 is fitted to one or both of the forward and rearward portions of the sensor mounting member 22 with respect to the direction of travel of the automotive vehicle, in a manner similar to that described hereinbefore, the use may be made of a temperature sensor 24 in the sensor unit 21 in addition to the strain sensor 23 as shown in FIG. 15 in connection with a seventh preferred embodiment of the present invention, or the use may be made of the additional sensors 25 such as, for example, an acceleration sensor and a vibration sensor in the sensor unit 21 in addition to the strain sensor 23 as shown in FIG. 16 in connection with an eighth preferred embodiment of the present invention. In such case, effects similar to those described hereinbefore can be obtained.

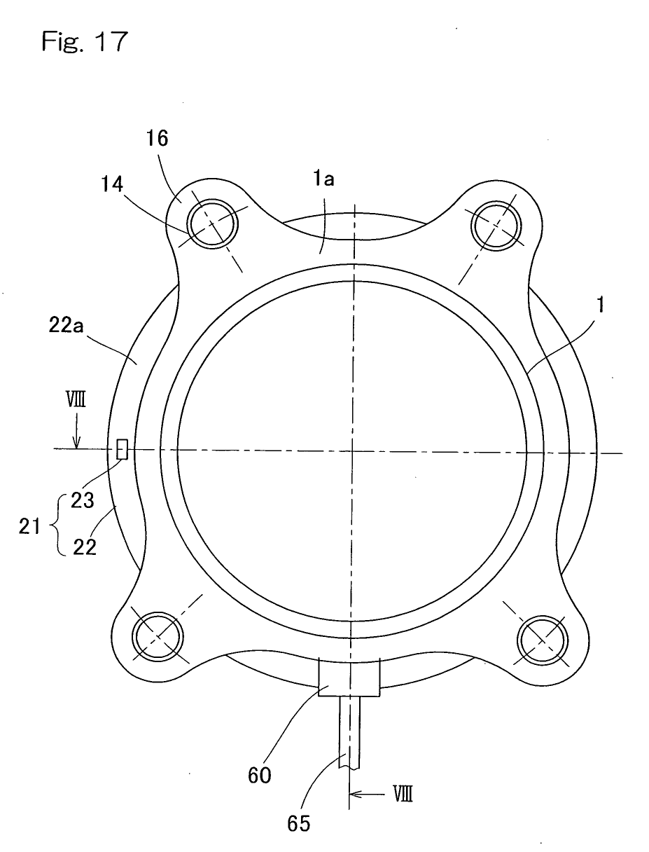

Also, as shown in FIG. 17 in connection with a ninth preferred embodiment of the present invention, the sensor signal processing circuit unit 60 can be incorporated in the wheel support bearing assembly. The sensor signal processing circuit unit 60 is fitted to an outer peripheral surface of the outer member 1. Even in such case, effects similar to those described hereinbefore can be obtained. It is to be noted that the cross-sectional view taken along the line VIII-VIII in FIG. 17 comes to be identical with FIG. 8.

It is to be noted that although in any one of the foregoing various embodiments, reference has been made to the outer member 1 serving as the stationary member, the present invention can be equally applied to the wheel support bearing assembly, in which the inner member serves as the stationary member, and, in such case, the sensor unit 21 is fitted sandwiched between the inner member and the knuckle.

It is also to be noted that although in any one of the foregoing various embodiments, the present invention has been shown and described as applied to the wheel support bearing assembly of the third generation type, the present invention can be equally applied to the wheel support bearing assembly of a second generation type, in which the bearing unit and the hub unit are respective component parts separate from each other, and also to the wheel support bearing assembly of a fourth generation type, in which a part of the inner member is constituted by an outer ring of a constant velocity universal joint. Yet, this sensor equipped wheel support bearing assembly can be applied to a wheel support bearing assembly for the support of a vehicle driven wheel. In addition, the present invention can be similarly equally applied to a tapered roller bearing of any generation type for the support of the vehicle wheel.

Any one of the foregoing various embodiments of the present invention encompasses the following modes:

### [Mode 1]

Even when the maximum expected force is applied as an external force acting on the stationary member or an acting force acting between the wheel tire and the road surface, the sensor unit does not undergo any plastic deformation. The maximum expected force referred to above is a maximum force that can be assumed during the travel of the automotive vehicle that does not lead to a trouble in such automotive vehicle. Once the plastic deformation occurs in the sensor unit, deformation occurring in the stationary member will not be transmitted accurately to the sensor mounting member of the sensor unit, thus adversely affecting the measurement of the strain.

### [Mode 2]

The sensor mounting member is a product prepared by the use of a press work. Where the sensor mounting member is manufactured by means of the press work, the processing can be accomplished easily and the cost can be reduced.

### [Mode 3]

The sensor mounting member is a product of a sintered metal that is formed by molding a powdery metal with the use of a metal injection molding technique. According to the injection molding of a powdery metal, a sintered element having a high sintered density as compared with that afforded by the standard powdery metallurgy can be obtained and a sintered metal product can also be prepared with a high dimensional accuracy and can have a high mechanical strength.

What is claimed is:

1. A sensor equipped wheel support bearing assembly for rotatably supporting a vehicle wheel relative to a vehicle body structure, which assembly comprises:
an outer member having an inner periphery thereof formed with a plurality of raceways;
an inner member formed with raceways in face-to-face relation with the respective raceways in the outer member;
a plurality of rows of rolling elements interposed between the respective raceways in the outer and inner members; and
a sensor unit including a sensor mounting member having bolt insertion holes defined therein in a relation alignable with respective vehicle body fitting holes defined in one of the outer member and the inner member that serves as a stationary member and at least one strain sensor mounted on the sensor mounting member, and fixedly sandwiched between the stationary member and a knuckle by means of bolts inserted through the vehicle body fitting holes and the bolt insertion holes,
wherein the sensor unit has a portion that has a radial dimension greater than that of a flange provided in the stationary member in contact with the knuckle.

2. The sensor equipped wheel support bearing assembly as claimed in claim 1, wherein the strain sensor is arranged on an uppermost or lowermost portion of the sensor mounting member or both of the uppermost and lowermost portions of the sensor mounting member.

3. The sensor equipped wheel support bearing assembly as claimed in claim 1, wherein the strain sensor is arranged at a location of the sensor mounting member forwardly or rearwardly, or at both of those locations thereof, with respect to the direction of travel of the automotive vehicle.

4. The sensor equipped wheel support bearing assembly as claimed in claim 1, wherein the sensor unit is of a type capable of detecting a force generated between the flange in the stationary member and the knuckle as a strain.

5. The sensor equipped wheel support bearing assembly as claimed in claim 1, wherein the stationary member is the outer member.

6. The sensor equipped wheel support bearing assembly as claimed in claim 1, further comprising an acting force estimation section for estimating, based on the output of the strain sensor, an external force acting on the wheel support bearing assembly or an acting force between a wheel tire and the road surface.

7. The sensor equipped wheel support bearing assembly as claimed in claim 1, further comprising a temperature sensor provided in the sensor mounting member.

8. The sensor equipped wheel support bearing assembly as claimed in claim 1, further comprising at least one of an acceleration sensor and a vibration sensor provided in the sensor mounting member.

9. The sensor equipped wheel support bearing assembly as claimed in claim 1, wherein the strain sensor includes an insulating layer formed on a surface of the sensor mounting member by means of printing and baking and electrodes and a strain measuring resistance element both formed on the insulating layer by means of printing and baking.

10. The sensor equipped wheel support bearing assembly as claimed in claim 1, further comprising a sensor signal processing circuit for processing an output signal of the strain sensor, provided in proximity of the sensor unit.
